(19) United States
(12) Patent Application Publication
(10) Pub. No.: US 2022/0358515 A1
(43) Pub. Date: Nov. 10, 2022

(54) CARBON EMISSIONS MANAGEMENT SYSTEM

(71) Applicant: The Boston Consulting Group, Inc., Boston, MA (US)

(72) Inventors: Olivier Roger Ali KAHN, Paris (FR); Charlotte DEGOT, Paris (FR); Mathilde Marie DUVERGER, Paris (FR); Antoine Louis René DEBUGNE, Paris (FR)

(21) Appl. No.: 17/690,787

(22) Filed: Mar. 9, 2022

Related U.S. Application Data
(60) Provisional application No. 63/186,065, filed on May 7, 2021.

(51) Int. Cl. G06Q 30/00; G06F 30/27

(52) U.S. Cl. CPC G06Q 30/018; G06F 30/27

(57) ABSTRACT

Methods, systems, and computer storage media for providing carbon emissions data analytics recommendations using a carbon emissions data analytics engine in a carbon emissions management system. The recommendation can be associated with simulated carbon emissions optimization results data based on carbon emissions data analytics model of the carbon emissions management system. In operation, using statistical modeling, existing carbon emissions factors of standard activities are retrieved, merged and augmented. Activity data (e.g., activity data of an organization) are automatically mapped to the carbon emissions factors. Input data comprising the activity data mapped to the augmented carbon emissions factors is processed using a carbon emissions data analytics models. Processing the input data can include forecasting, scenario simulation, and scenario optimization. Based on processing the input data, output data associated with a plurality of abatement levers can be generated The output data can be communicated an caused to be displayed with graphical interface elements.

### CROSS-REFERENCE TO RELATED APPLICATIONS

The present application claims the benefit of U.S. Provisional Application No. 63/186,065, filed on May 7, 2021 and entitled “CARBON EMISSIONS MANAGEMENT SYSTEM,” the entirety of which is incorporated by reference herein.

### BACKGROUND

Many corporations rely on tracking systems to manage different types of aspects of their business platforms, from manufacturing processes to human resources. Carbon emissions management systems can be used to support their initiatives for limiting their environment impact such as carbon emissions. For example a corporation may track carbon emissions in order to manage sustainability data and report on their carbon footprint. A carbon emissions management system can operate based on measuring a carbon footprint for an individual, organization, or nation, where measuring the carbon footprint can be based on different types of carbon accounting techniques (e.g., greenhouse emissions assessment, a life cycle assessment). The carbon emissions management system can support developing a strategy to reduce the carbon footprint, for example, via carbon offsetting, carbon capture, better process management, energy efficient, and technological developments.

Conventional carbon emissions management systems are not configured with a computing infrastructure and logic to identify sophisticated insights and trends in carbon emissions-related practices and—based on the insights and trends—provide recommendations on how to meet strategic goals with regard to carbon emissions initiatives. For example, a conventional carbon emissions management system can provide a high level framework for calculating a total amount of carbon emissions, but lack granularity in carbon emissions data to drive additional actions for meeting carbon cutting goals. As such, a more comprehensive carbon emissions management system—an alternative basis for performing carbon emissions management operations—can improve computing operations and interfaces for carbon emissions management.

### SUMMARY

Various aspects of the technology described herein are generally directed to systems, methods, and computer storage media, for among other things, providing carbon emissions data analytics recommendations (“recommendations”) using a carbon emissions data analytics engine (“analytics engine”) in a carbon emissions management system. The recommendation can be associated with simulated carbon emissions optimization results data based on carbon emissions data analytics model of the carbon emissions management system. The simulated carbon emissions optimization results data refers to outputs (i.e., predicted behavior for carbon emissions) of a carbon emissions data analytics model. The carbon emissions data analytics model can process different data types of carbon emissions model input data and generate data visualizations that include the simulated carbon emissions optimization results data. The simulated carbon emissions optimization results data can be generated using carbon emissions factors of different activities, where a carbon emissions factor supports estimating pollution associated with each activity (i.e., quantifies a pollutant released into the atmosphere with an activity associated with the release of that pollutant).

In operation, using statistical modeling, existing carbon emissions factors of standard activities are retrieved, merged and augmented. Activity data (e.g., activity data of an organization) are automatically mapped to the carbon emissions factors to generate activity-carbon-emissions data. Input data—comprising the activity-carbon-emissions data—is processed using a carbon emissions data analytics model. Processing the input data can include forecasting, scenario simulation and scenario optimization. Based on processing the input data, output data (e.g., a carbon emissions data analytics recommendation) associated with a plurality of abatement levers can be generated. The output data can be communicated and caused to be displayed with graphical interface elements (e.g., a dashboard visualizations).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary carbon emissions management system with a carbon emissions data analytics engine, in which embodiments described herein may be employed;

FIGS. 1C-1E are exemplary interfaces associated with a carbon emissions management system with a carbon emissions data analytics engine, in which embodiments described herein may be employed;

FIGS. 2A and 2B are block diagrams of an exemplary carbon emissions management system with a carbon emissions data analytics engine, in which embodiments described herein may be employed;

FIGS. 2C and 2D are exemplary schematics associated with a carbon emissions management system with a carbon emissions data analytics engine, in which embodiments described herein may be employed;

FIGS. 2E-2H are exemplary interfaces associated with a carbon emissions management system with a carbon emissions data analytics engine, in which embodiments described herein may be employed;

FIG. 3 is a flow diagram showing an exemplary method for implementing a carbon emissions management system with a carbon emissions data analytics engine, in accordance with embodiments described herein;

FIG. 4 is a flow diagram showing an exemplary method for implementing a carbon emissions management system with a carbon emissions data analytics engine, in accordance with embodiments described herein;

FIG. 5 is a flow diagram showing an exemplary method for implementing a carbon emissions management system with a carbon emissions data analytics engine, in accordance with embodiments described herein;

FIG. 6 provides a block diagram of an exemplary distributed computing environment suitable for use in implementing aspects of the technology described herein; and

FIG. 7 is a block diagram of an exemplary computing environment suitable for use in implementing aspects of the technology described herein.

### DETAILED DESCRIPTION

### Overview

By way of background, carbon emissions management systems can be used to support carbon cutting initiatives that limit environmental impact of carbon emitting activities. For example a corporation may track carbon emissions in order to manage sustainability data and report on their carbon footprint. A carbon footprint is the total amount of greenhouse gas (GHG) emissions that come from the production, use and end-of-life of a product or service. It includes carbon dioxide—the gas most commonly emitted by humans—and others, including methane, nitrous oxide, and fluorinated gases, which trap heat in the atmosphere, causing global warming. A carbon emissions management system can operate based on measuring a carbon footprint for an individual, organization, or nation, where measuring the carbon footprint can be based on different types of carbon accounting techniques (e.g., greenhouse emissions assessment, a life cycle assessment). The carbon emissions management system can support developing a strategy to reduce the carbon footprint, for example, via carbon offsetting, carbon capture, better process management, energy efficient, and technological developments.

Conventional carbon emissions management systems are limited in their capacity to provide sophisticated insights and trends in carbon emissions-related practices and provide recommendations on how to meet strategic goals with regard to carbon emissions initiatives. Many corporations commit to limiting their environmental impact—in particular their carbon emissions—however, practically implementing initiatives can be challenging. For example, there exist no carbon emissions management systems that can provide insights and transparency on specific carbon emissions data and corresponding activities that are sources of carbon emissions.

Moreover, carbon emissions management systems do not provide carbon emissions data that identify potential solutions, nor do they show a comprehensive view of carbon emissions data and impact across different aspects of an organization's business platform. For example, a conventional carbon emissions management system can provide a high level framework for calculating a total amount of carbon emissions, but lack granularity in carbon emissions data to drive additional actions for meeting carbon cutting goals. As such, a more comprehensive carbon emissions management system—an alternative basis for performing carbon emissions management operations—can improve computing operations and interfaces for carbon emissions management.

Embodiments of the present disclosure are directed to systems, methods, and computer storage media, for among other things, providing carbon emissions data analytics recommendations (“recommendations”) using a carbon emissions data analytics engine (“analytics engine”) in a carbon emissions management system. The recommendation can be associated with simulated carbon emissions optimization results data based on carbon emissions data analytics model of the carbon emissions management system. The simulated carbon emissions optimization results data refers to outputs (i.e., predicted behavior for carbon emissions) of a carbon emissions data analytics model. The carbon emissions data analytics model can process different data types of carbon emissions model input data (e.g., activity-carbon-emissions data) and generate data visualizations that include the simulated carbon emissions optimization results data. The simulated carbon emissions optimization results data can be generated using carbon emissions factors of different activities, where a carbon emissions factor supports estimating pollution associated with each activity (i.e., quantifies a pollutant released into the atmosphere with an activity associated with the release of that pollutant).

By way of context, machine learning approaches to data analytics allow learning from data and improving analysis via data analytics systems. Operationally, developing a machine learning model for data analytics can be performed via a machine learning engine that supports gathering training data, defining goals and metrics associated with training data features or attributes (e.g., carbon emission features, activity features, etc.) Machine learning techniques can include Long Short-Term Memory (LSTM), Random Forest, and Linear Regression to develop carbon emissions data analytics models. For example, a linear regression approach can help predict future values from past values based on identifying underlying trends, so using historical data, additional information about the specific activity, value chain, geographical location, and carbon emissions factor, a predicted future value can be provided as a recommendation. The machine learning engine can further support training the carbon emissions data analytics models (i.e., using historical data and algorithms), validation (i.e., optimizing data analytics model parameters and hyper-parameters), and deployment (e.g., integration into production use) different types of computing environments.

Data analytics systems can be configured to operate with a carbon emissions management system. The carbon emissions management system can include a carbon emissions management computing environment that supports a business or organization in managing how to limit their environmental impact by reducing their carbon emissions. The carbon emissions management system can support getting transparency into where carbon emissions are generated from, and finding solutions to reduce their carbon emissions—advantageously with positive financial impact. In this way, the carbon emissions management system can support generating simulated carbon emissions optimization results data that can be embedded in an automated collaborative platform which offers an intuitive dashboard, scenarios versioning and simulations, and optimization execution functionality.

Carbon emissions data analytics recommendations can be generated using carbon emissions data analytics engine. The carbon emissions data analytics engine provides both transparency on carbon emissions and levers to reduce carbon emissions at scale. In particular, using statistical modeling, existing carbon emissions factors of standard activities are retrieved, merged and augmented. Activity data (e.g., activity data of an organization) are automatically mapped to the carbon emissions factor to generate activity-carbon-emissions data. Activity data can be associated with a value chain of an organization that is programmatically defined in a value chain model. The value chain can refer to a business model that describes a full range of activities needed to create a product or service. The carbon emissions factors mapped to the activity data can be referred to as activity-carbon-emissions data. Input data comprising the activity-carbon-emissions data is processed using a carbon emissions data analytics model. Processing the input data can include forecasting, scenario simulation, and scenario optimization. Based on processing the input data, output data (e.g., a carbon emissions data analytics recommendation) associated with a plurality of abatement levers can be generated The output data can be communicated and caused to be displayed with graphical interface elements (e.g., a dashboard visualizations).

As such, the carbon emissions management system can operate to quantify carbon emissions. Carbon emissions can be quantified as carbon emissions data and specifically for an organization's activities (e.g., a value chain model). Quantifying carbon emissions can be based on a mixture of statistical methods, advance forecasting and scenario modeling techniques. In this way, the carbon emissions management system supports fast and accurate results data and enables simulation-based decisions and specifically what abatement levers provide a desired outcome for carbon emissions at scale.

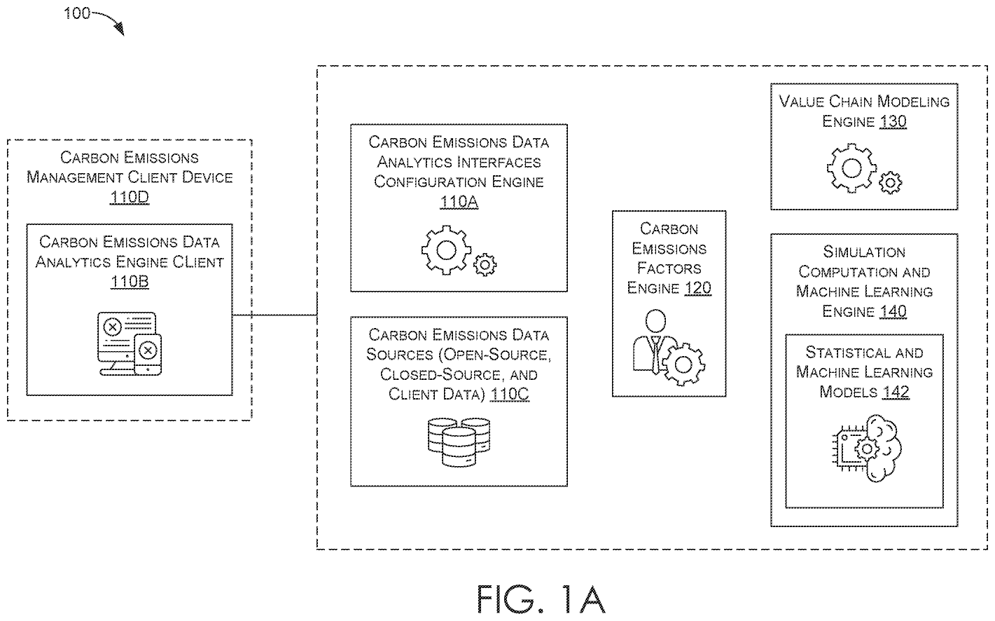

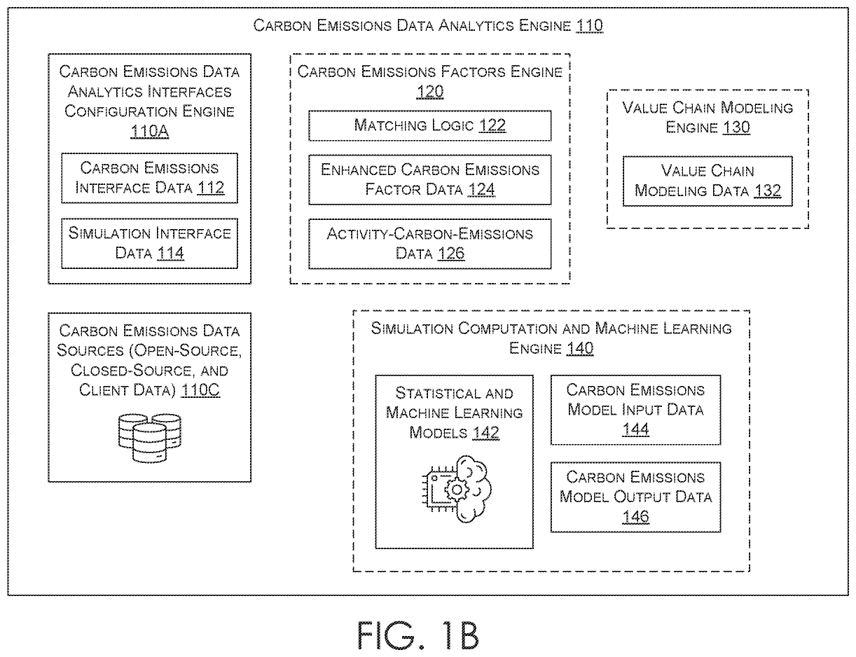

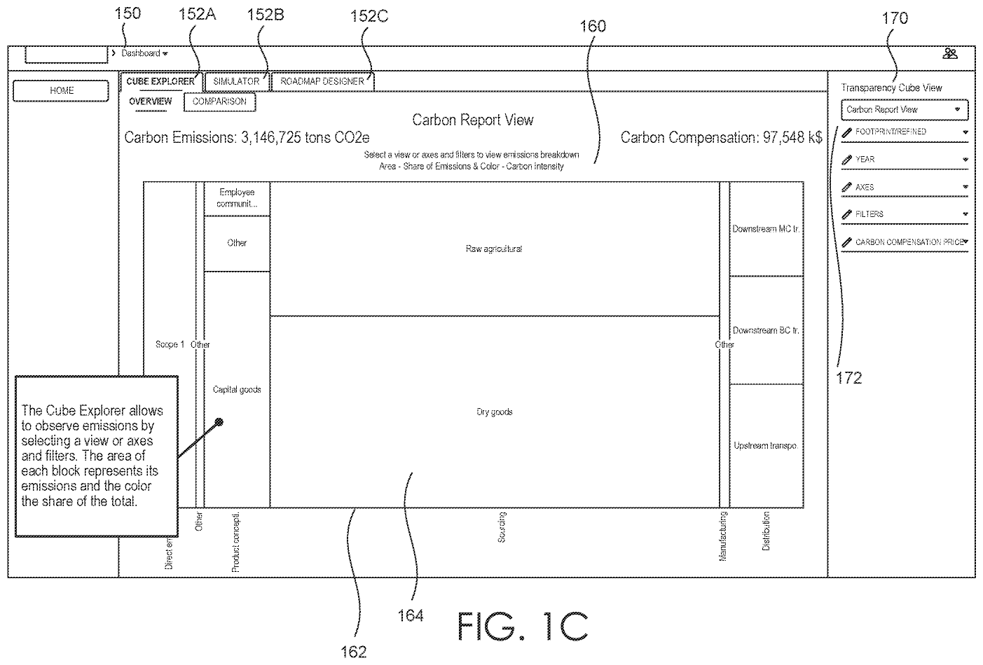

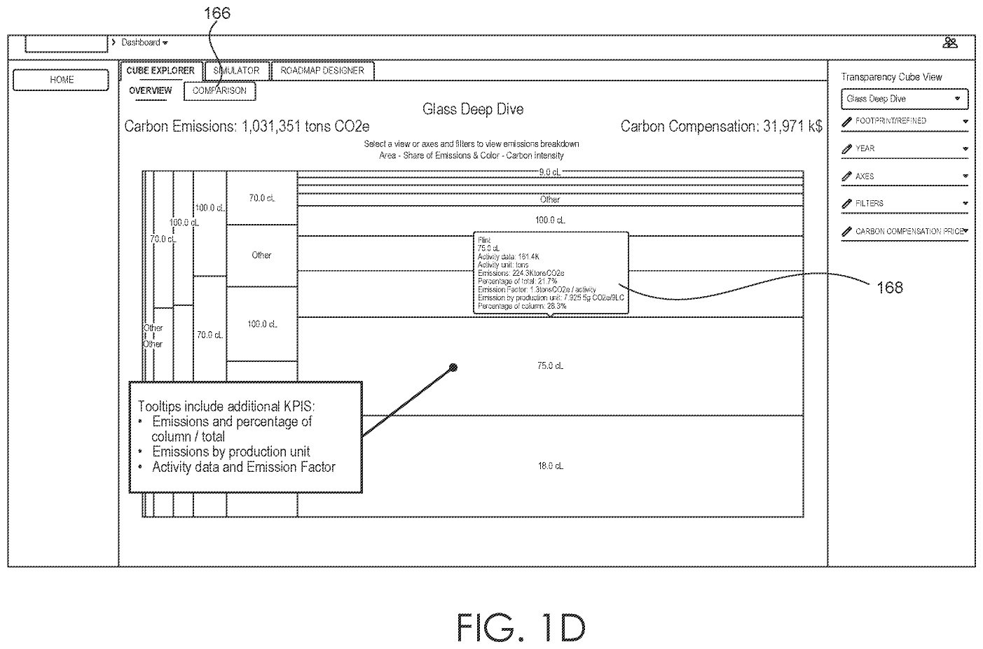

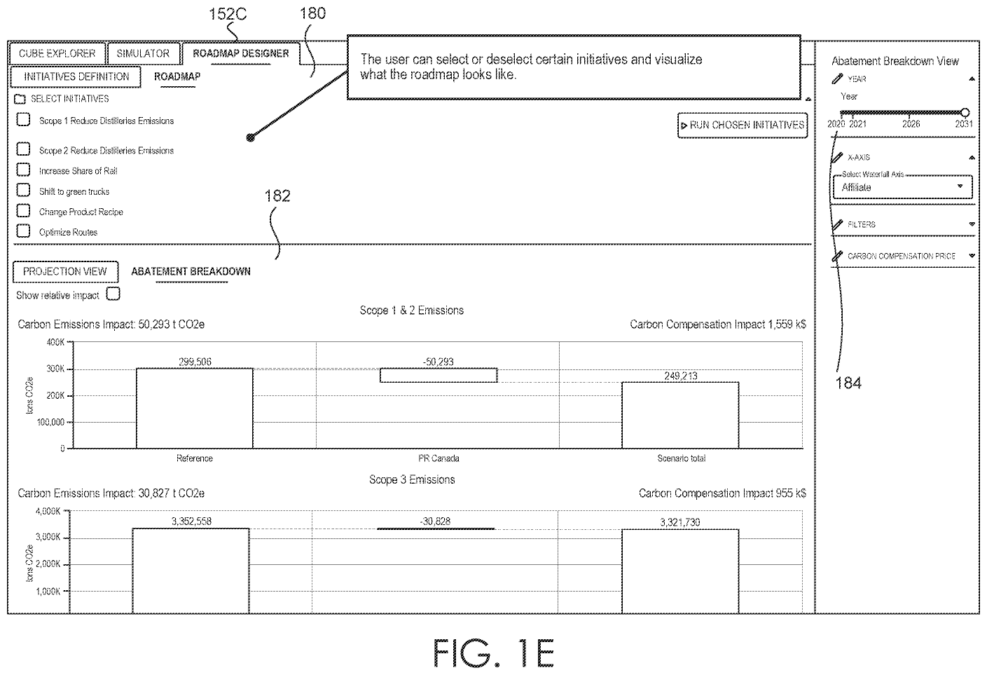

Aspects of the technical solution can be described by way of examples and with reference to FIGS. 1A-1D. FIG. 1A illustrates a carbon emissions management system 100 including carbon emissions data analytics engine 110, carbon emissions data analytics interfaces configuration engine 110A, carbon emissions data analytics engine client 110D having carbon emissions data analytics engine client 110B, carbon emissions data sources 110C (e.g., open-source, close-source, client data) and carbon emissions factors engine 120, value chain modeling engine 130, and simulation computation and machine learning engine 140 having statistical and machine learning models 130.

With reference to FIG. 1B, FIG. 1B illustrates aspects of the carbon emissions data analytics engine 110. FIG. 1B includes carbon emissions data analytics interfaces configuration engine 110A having carbon emissions interface data 112 and simulation interface data 114; carbon emissions data sources 110C (e.g., open-source, close-source, client data); carbon emissions factors engine 120 having matching logic 122, enhanced carbon emissions factor data 124, and activity-carbon-emissions data 126, value chain modeling engine 130 having value chain modeling data 132, and simulation computation and machine learning engine 140 having statistical and machine learning models 142, carbon emissions model input data 144, and carbon emissions model output data 146.

At a high level, the carbon emissions management system 100 supports consolidating and enriching carbon emissions factors (e.g., carbon emissions factors engine 120), modeling a value chain (e.g., value chain modeling engine 130); generating activity-carbon-emissions data via matching (e.g., matching logic 122 and activity-carbon-emissions data 124); visualizing baseline carbon emissions data (e.g., carbon emissions interface data 112 and carbon emissions data analytics interfaces configuration engine 110A); and simulating abatement levers from the baseline carbon emissions data (e.g., carbon emissions data analytics engine configuration engine). The carbon emissions system 100 implements statistical methods, advance forecasting and scenario modeling techniques (e.g., simulation computation and machine learning engine 140) to support the functionality described above.

The carbon emissions factors engine 120 operates to consolidate and enrich carbon emissions factor. The carbon emissions factors can be defined in an enhanced carbon emissions factors database. The carbon emission library can be generated by consolidating open-access data and also based on acquiring licenses to different database. In addition, the enhanced carbon emissions factors database can be extended to include computed carbon emissions factors for complex products and processes. For example, the enhanced carbon emission factors database can be associated with vehicles and corresponding mobile combustion carbon emissions factors. The enhanced carbon emissions factors database for a vehicle can identify the vehicle type, fuel type, vehicle year, CH₄ factor and N₂O factor. The enhanced carbon emission factors can further identify a value chain model and corresponding organization or entity associated with the value chain model.

The value chain modeling engine 130 operates to generate value chain models based on activity data. Activity data can be associated with individual activities of a value chain model. For example, the value chain model can be associated with a manufacturing process that includes transportation of resources, processing of resources, and delivery of resources, where each of these activities—independently or in combination—are associated with the manufacturing process that corresponds to one or more carbon emissions factors. Activity data (e.g., client data) can be processed to generate value chain models that are stored and processed as value chain modeling data 132 to support quantifying carbon emissions data for carbon emissions sources of the value chain model. In this way, the carbon emission factors and activity data of the activities can be used to generate the activity-carbon-emissions data, as discussed in more detail below. Other variations and combinations of enhanced carbon emissions factors and value chain models are contemplated with embodiments described herein.

The carbon emissions factors engine 120 operates to generate activity-carbon-emissions data 126. The activity-carbon-emissions data 126 is generated using matching logic 122 (e.g., fuzzy matching or string matching) and enhanced carbon emissions factor data 126. Value chain modeling data (e.g., granular hierarchical tree of activities) is mapped to enhanced carbon emissions factor data using a variety of techniques. For example, a fuzzy matching can be used to match the descriptions of an activity to a description of a carbon emissions factor. The granularity of the tree of activities and using statistical methods for inference support improving the accuracy in the processes of the carbon management system. Statistical methods (e.g., simple regression, multi-variate regressions, or machine-learning models) are used to make inferences of missing data in the carbon emissions factors data. For example, an inference can be made with reference to the energy intensity of a processing step—in the value chain model—in a country for which the data does not exist. Data augmentation and similar techniques can be used to generate synthetic data (or synthetic carbon emissions data) that can be used to generate activity-carbon-emissions-data.

The carbon emissions data analytics interfaces configuration engine 110A operates to provide carbon emission interface data 112 and simulation interface data. The carbon emissions factors engine generates activity-carbon emissions data which is used to generated carbon emissions interface data 112. In other words, based on matching the value chain modeling data to the enhanced carbon emissions factor data, a carbon emissions interface data (e.g., baseline carbon emissions model). The simulation computation and machine learning engine 140 can be used to generate the simulation interface data 114 associated with assessing the impact of different abatement levers. Abatement levers can refer activities or actions that can be taken to reduce pollution, these activities or actions can be associated with a quantified measure of potential GNG reductions. For example, abatement levers can include installing solar panels on X stores in five countries, optimizing routing in transport networks, or switching a source material for a sustainable alternative). In this way, assessing the impact can be based on client-specific simulations that are built from the baseline model of carbon emissions, where abatement levers can be determined based on simulation computation and machine learning engine, statistical methods, advance forecasting and scenario modeling techniques. Thus, the improved carbon emissions management system provides systematic usage of simulations to inform and prioritize abatement levers.

The carbon emissions data analytics interfaces configuration engine 110A uses output data (e.g., carbon emissions model output data) generated from input data (e.g., carbon emissions model input data) to provide different types of data visualizations including the following: standardized visualizations (e.g., an interactive heat map) which can be explored by drilling into the activities tree to any required level of granularity; future projections of the emissions and carbon offsetting costs; comparison screens (waterfall-like) showing the impact of abatement simulations compared to the baseline. Simulating the effect of select abatement levers on the emission baseline can be based on a mix of simple formulae, stochastic simulations (MCMC) and math (e.g. installing solar panels on X stores in five countries, optimizing routing in transport networks, switching a source material for a sustainable alternative). Optimization techniques (e.g. MIPs) can be implemented to simulate the effects of select abatement levers on the emissions baseline.

With reference to FIGS. 1C and 1D, FIGS. 1C and 1D illustrate aspects—interface representations—associated with the carbon emissions analytics engine 110, the carbon emissions data analytics interfaces configuration engine 110A, and the carbon emissions data analytics engine client 110B. At a high level, the carbon emissions data analytics interfaces configuration engine 110A operates to generate interface data (e.g., carbon emissions interface data 112 and simulation interface data 114). Interface data includes user interface elements, carbon emissions data analytics data, and instructions on how to generate corresponding user interfaces that support interactions between users and the carbon emissions management system.

User interfaces allow effective operation and control by users while the carbon emissions management system simultaneously perform computing operations. Interface data can include graphical user interfaces that allow users to interact with the carbon emissions management system (e.g., carbon emissions management tool) through graphical user interface elements. A graphical user interface can include a dashboard that provides a visual display of data (e.g., carbon emissions interface data 112 and simulation interface data 114). The carbon emissions interface data and simulation interface data can specifically be associated with simulated carbon emissions optimization results data based on carbon emissions data analytics models.

Turning to FIG. 1C, FIG. 1C illustrates a carbon emissions data analytics interface 150 associated with the carbon emissions data analytics engine 110. In particular, the carbon emissions data analytics interface 150 supports causing display of the carbon emissions data analytics recommendation including generating a plurality of dashboard visualizations having graphical interface elements corresponding to output data associated with the carbon emissions data analytics recommendation. The carbon emissions data analytics interface 150 can be associated with a plurality of tabs (e.g., cube explorer 152A, simulator 152B, and roadmap designer 152C tab) that support a variety of functionality of the carbon emission data analytics engine that are accessible via the carbon emissions data analytics interface 150.

The carbon emissions data analytics interface 150 can include a dashboard with a carbon report view interface portion 160 and a transparency cube view interface portion 170. The carbon report view interface portion 160 can include carbon emissions data associated with activities of a value chain model. For example, the carbon report view interface portion 160 can be implemented as a cube explorer 162 where the cube explorer supports observing emissions by selecting a view or axes and filters. The area (e.g., dry good area 164) of each block represents a share of the total emissions. The transparency cube view interface 170 further provides a plurality of selectable views, axes, and filters (e.g., transparency cube view, axes, and filters 172) that can be selected to update the carbon emissions data in the carbo report view interface portion 160. In the way, the carbon report view interface portion 162 visually summarizes carbon emissions data for additional analysis. For example, as shown in FIG. 1D, a comparison 166 tab can be active such that hovering over an area (e.g., area 168) of the carbon report view interface portion 160 presents carbon emissions data. The carbon emissions data associated with the area can include tooltips associated with Key Performance Indicators (KPIs) corresponding to carbon emissions data and a percentage of total; emissions by production unit; and activity data and emissions factors.

Turning to FIG. 1E, FIG. 1E illustrates a carbon emissions data analytics interface 150 with the roadmap designer 152 tab active. The roadmap designer 152 can support presenting a roadmap designer interface portion 180, where the user can select or deselect certain initiatives and visualize what a roadmap for a value chain model looks like. For example, the roadmap designer 152C tab can specifically include carbon emissions data that is associated with abatement levers where an abatement breakdown view interface portion 182 supports presenting detailed carbon emissions data associated with abatement. The abatement breakdown view interface portion 182 further provides a plurality of selectable axes and filters (e.g., abatement breakdown view axes and filters 182) that can be selected to update the carbon emissions data in the abatement breakdown view interface portion.

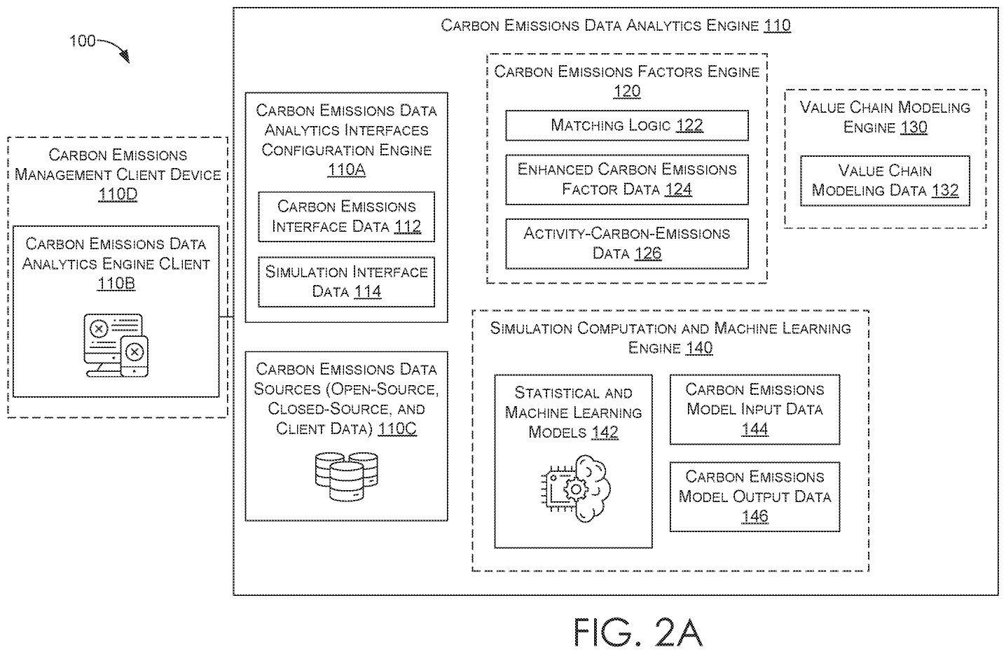

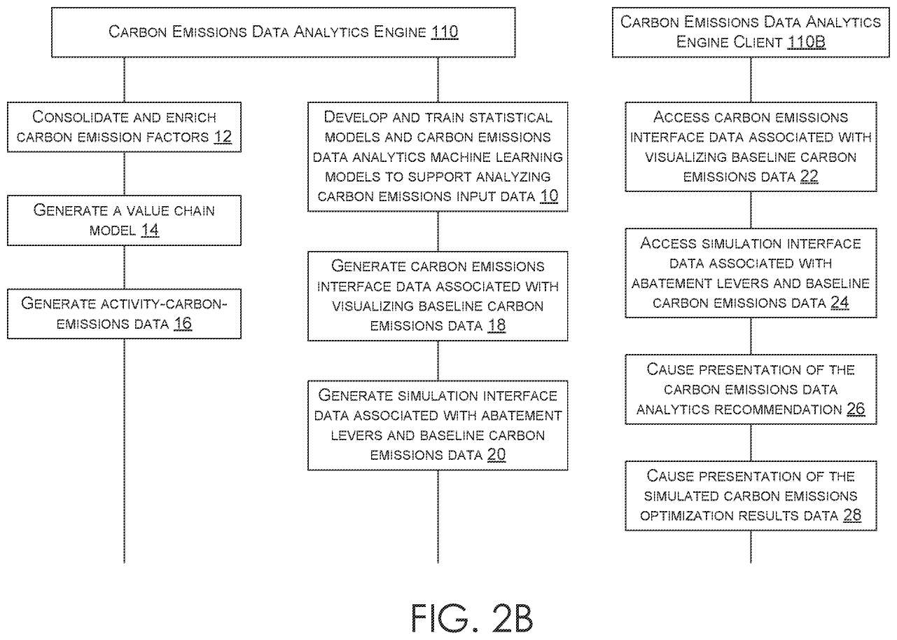

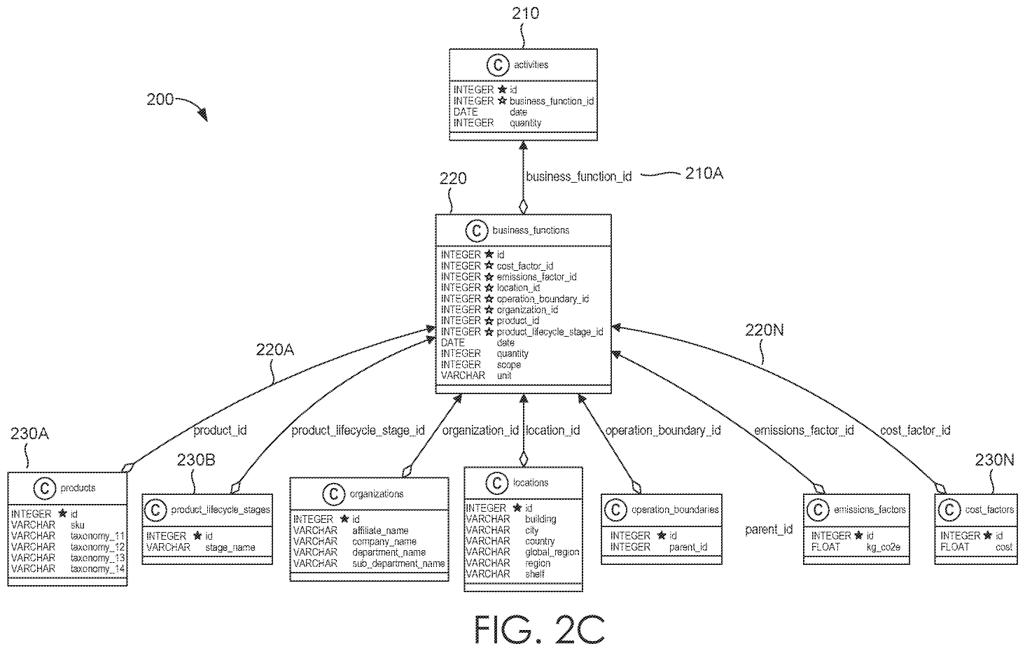

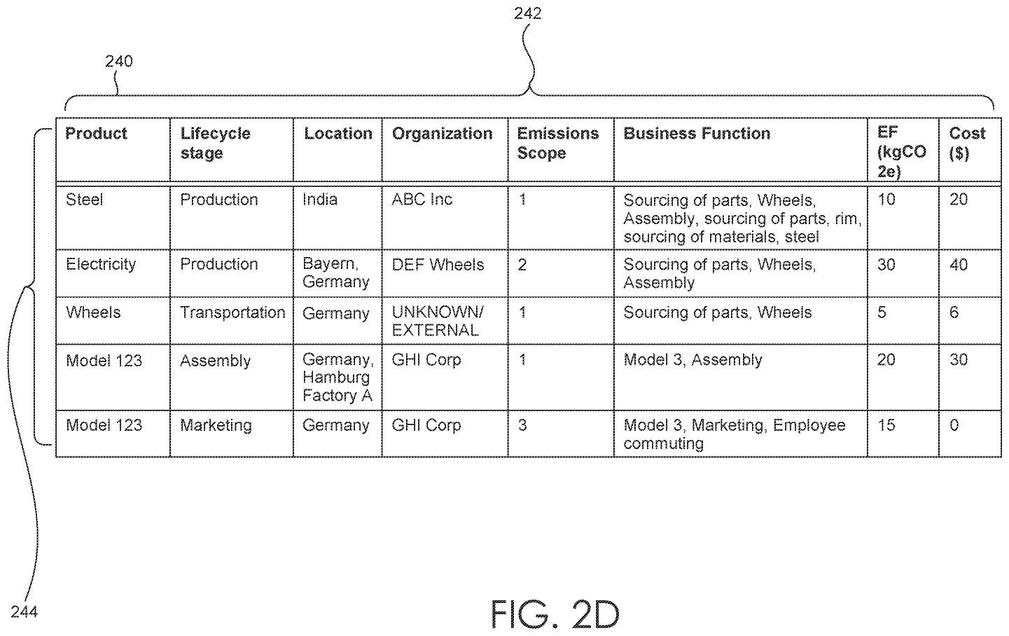

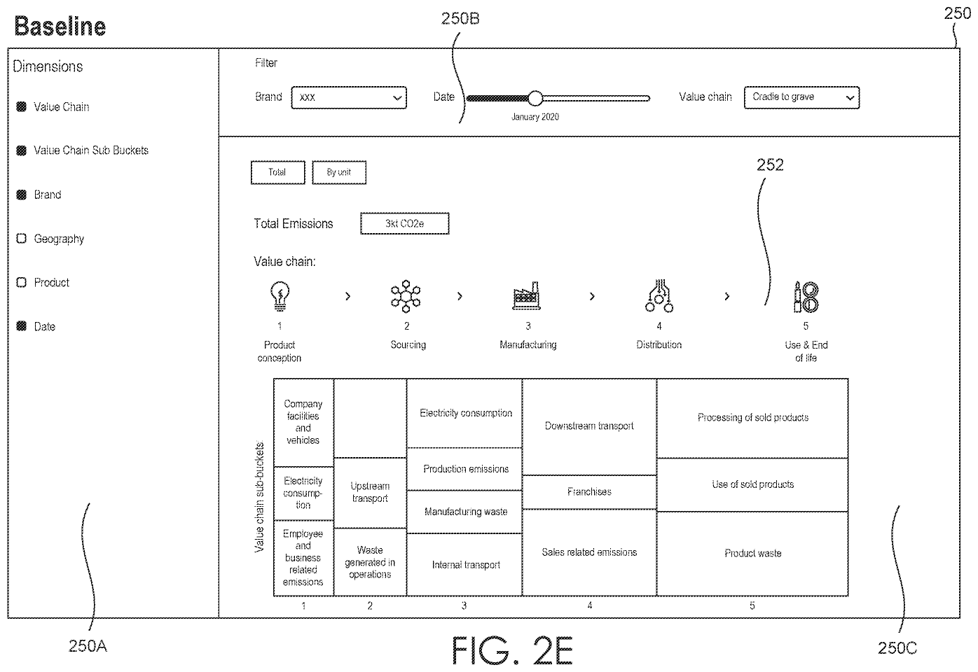

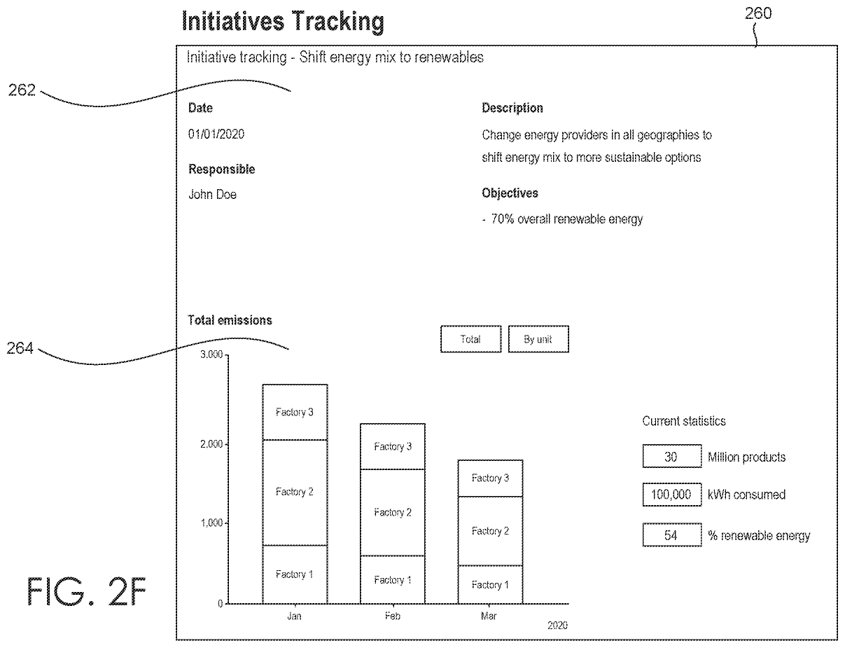

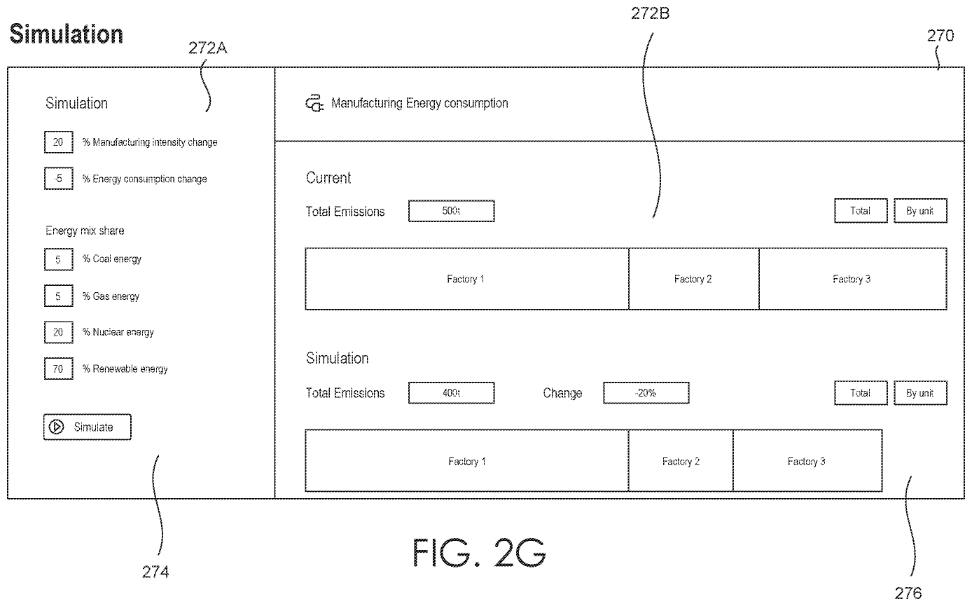

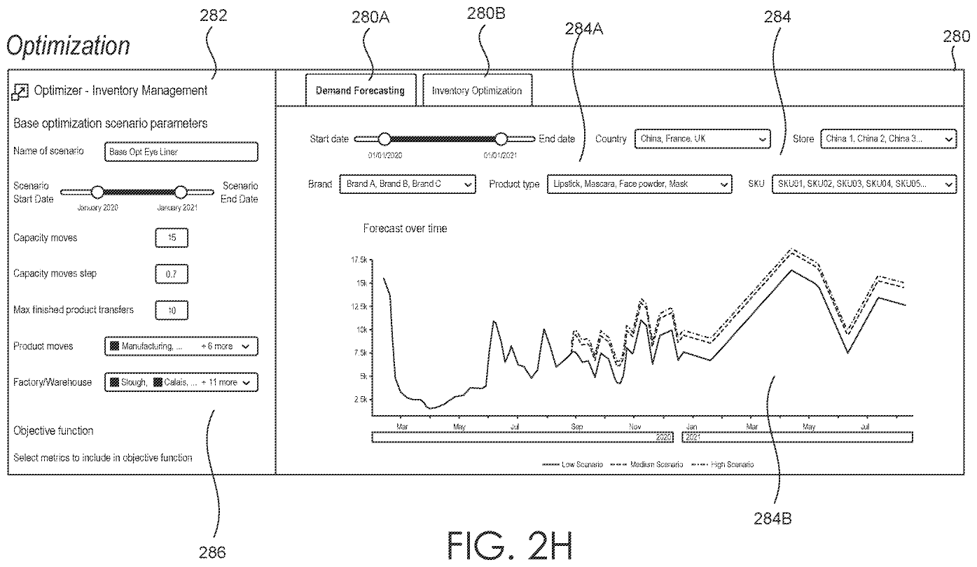

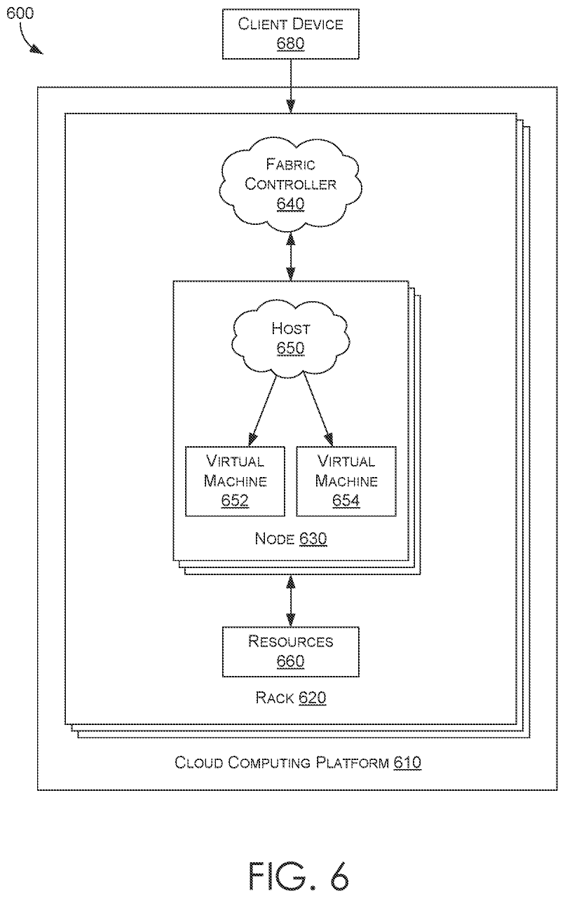

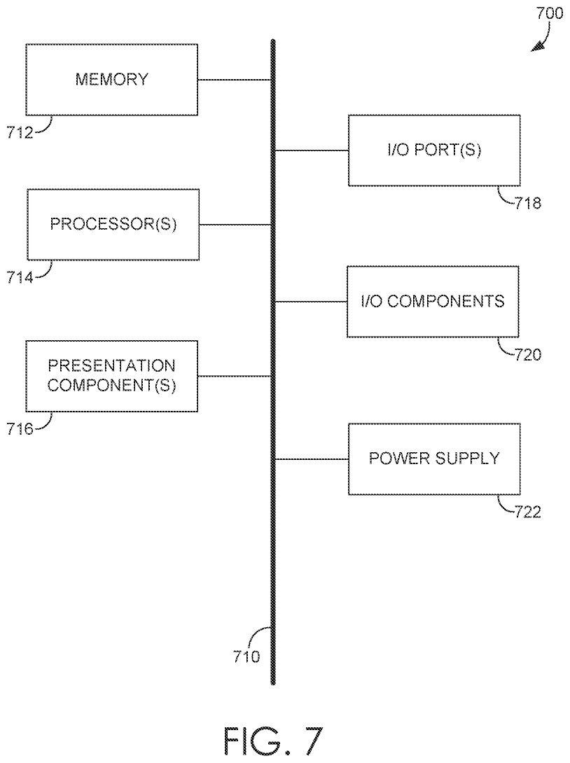

Aspects of the technical solution can be described by way of examples and with reference to FIGS. 2A and 2B. FIG. 2A is a block diagram of an exemplary technical solution environment, based on example environments described with reference to FIGS. 6 and 7 for use in implementing embodiments of the technical solution are shown. Generally the technical solution environment includes a technical solution system suitable for providing the example carbon emissions management system 100 in which methods of the present disclosure may be employed. In particular, FIG. 2A shows a high level architecture of the carbon emissions management system 100 in accordance with implementations of the present disclosure. Among other engines, managers, generators, selectors, or components not shown (collectively referred to herein as “components”), the technical solution environment of carbon emissions management system 100 corresponds to FIG. 1A and 1B.

With reference to FIG. 2A, FIG. 2A illustrates a carbon emissions management system 100 including carbon emissions data analytics engine 110, carbon emissions data analytics interfaces configuration engine 110A, carbon emissions data analytics engine client 110D having carbon emissions data analytics engine client 110B, carbon emissions data sources 110C (e.g., open-source, close-source, client data), carbon emissions factors engine 120, value chain modeling engine 130, and simulation computation and machine learning engine 140 having statistical and machine learning models 140. The carbon emissions factors engine 120 includes matching logic 122, enhanced carbon emissions factor data 124, and activity-carbon-emissions data 126, the value chain modeling engine 130 includes value chain modeling data 132, and simulation computation and machine learning engine 140 includes statistical and machine learning models 142, carbon emissions model input data 144, and carbon emissions model output data.

The carbon emissions data analytics engine 110 supports providing carbon emissions data analytics recommendations. At a high level, the carbon emission data analytics engine provide transparency on carbon emissions and abate levers to reduce carbon emissions at scale. Advantageously, the carbon emission data analytics engine 110 supports a combination of statistical and machine learning methods, forecasting, and scenario modeling techniques that quantify carbon emissions data corresponding to client activities and further enables simulation-based decision associated with abatement levers.

Carbon emissions data 110C (e.g., open-source data, closed-source data, and client data) can be retrieved, merged and augmented from carbon emission factor databases of standard activities. The carbon emissions data 110 can be enhanced to generate enhanced carbon emissions factor data 124 by combining data sources to compute emission factors for complex products and processes (e.g., toasters and refining processes).

With reference to FIG. 2C, FIG. 2C illustrates a value chain model 200 having a plurality of tables with table elements that correspond to activities of a client value chain model. At a high level, a value chain model engine 130 can retrieve value chain modeling data associated with activities of a client to generate a value chain model of a plurality of activities of the clients. The value chain modeling engine 130 supports a hierarchical and granular client activity framework that models client activities into a value chain model. For example, the value chain model 200 includes activities table 210, business functions table 220, and a plurality of business function elements tables (e.g., 230A, 230B . . . 230N). The activities table 210 is mapped 210A to the business functions table 220 and each of the business function elements tables are mapped (e.g., 220A, 220B . . . 250N) are mapped to the business functions table. The value chain model 200 can be mapped to carbon emissions data, as discussed in more below. In this way, the construction of the value chain model systematically breaks down client activity data into components at quantifiable levels that can be used for performing functionality supported via the carbon emissions data analytics engine.

Carbon emissions factors engine 120 supports automatically mapping client activity data to the enhanced carbon emissions factors 124 using matching logic 122. Mapping the client activity data to enhanced carbon emissions factors supports generating activity-carbon-emission data 126. The mapping logic 122 can be associated with statistical methods, from simple regression to machine learning models that are used to close gaps and generate missing data. For example, an inference can be made to determine a quantified energy intensity of a processing step in a country for which that data is unavailable).

With reference to FIG. 2D, FIG. 2D illustrates a carbon emissions data tabular representation 240 associated with the hierarchical and granular client activity framework. The carbon emissions data tabular representation 260 includes a plurality of attributes (e.g., product, lifecycle stage, location, organization, emissions scope, business function, Emissions Factor (EF) and cost) with corresponding values for the plurality of attributes. The combination of the value chain model 200 and enhanced carbon emissions factor data 124 can be used to generate a carbon emissions baseline of a client activity or process associated with the value chain model. The granularity of the value chain model and the statistical and machine learning models 142, advantageously, improve carbon emissions data accuracy and automate matching the carbon emissions factors to client activity data. Moreover, the carbon emissions baseline can be used to generate client-specific simulations to assess the impact of different abatement levers.

The simulation computation and machine learning engine 140 support leveraging statistical and machine learning models 142 to process carbon emissions model input data 144 into carbon emission model output data 146. For example, processing carbon emissions model input data can include extracting actionable levers from the data, through emission forecasting, scenario simulation, and scenario optimization. The output data can be processed through carbon emissions data analytics interfaces configuration engine 110A to generate carbon emission interface data 112 and simulation interface data 114. For example, the carbon emission model output data 146 can be provided to the carbon emissions management client device 110D having a carbon emissions data analytics engine client 110B that provides an automated collaborative platform which offers intuitive dashboard, scenarios version and simulation optimization runs.

With reference to FIG. 2B, FIG. 2B illustrates a carbon emissions data analytics engine 110 and a carbon emissions data analytics engine client 110B that support performing operations to provide carbon emissions data analytics recommendations using a carbon emissions data analytics engine in a carbon emissions management system. At block 10, statistical models and carbon emission data analytics machine learning models are developed and trained to support analyzing carbon emissions input data. At block 12, carbon emission factors are consolidated and enriched. Consolidating and enriching the carbon emissions factors based on pre-processing carbon emission factors from a plurality of carbon emissions factors data sources, where pre-processing the carbon emissions factors comprises retrieving, merging and augmenting the carbon emissions factors. At block 14, a value chain model is generated. At block 16, activity-carbon-emissions data is generated. The carbon emissions activity data can be generated using a matching logic that maps carbon emissions factors to activity data. The activity data is associated with activities of the value chain model. Based on mapping the carbon emissions factors to the activity data, the activity-carbon-emissions data can further include synthetic carbon emissions data. At block 18, carbon emissions interface data associated with visualizing carbon emissions data is generated. At block 20, simulation interface data associated with abatement levers and baseline carbon emissions data are generated. The carbon emissions interface data and the simulation interface data can be communicated to a carbon emissions data analytics client engine that supports a collaborative platform for presenting dashboards, scenario versioning and simulations, and comparisons to baseline carbon emissions data.

At block 22, using a carbon emissions data analytics client engine, carbon emissions interface data is accessed. The carbon emissions interface data is associated with visualizing baseline carbon emissions data. At block 24, simulation interface data associated with abatement levers and baseline carbon emissions data is accessed. At block 26, carbon emission data analytics recommendations are caused to be presented. The carbon emissions data analytics recommendation can include simulated carbon emissions optimization results based on predicted carbon emissions data associated with activities of the value chain model. The carbon emissions data analytics recommendation can further include abatement levers that support quantifying how to reduce predicted carbon emissions associated with the activities of the value chain model. Moreover, causing presentation of the carbon emissions data analytics recommendation can include generating a plurality of dashboard visualizations having graphical interface elements corresponding to carbon emissions output data associated with the carbon emissions data analytics recommendation. At block 28, simulated carbon emissions optimization results data are caused to be presented. The simulated carbon emissions optimization results data can be caused to be presented based on causing simulation of an effect of selecting one or more of a plurality of abatement levers on a carbon emissions based of the value chain model.

With reference to FIGS. 2E-2H, FIG. 2E-2H illustrate aspects—interface representations—associated with the carbon emissions data analytics engine 110, the carbon emissions data analytics interfaces configuration engine 110A, and the carbon emissions data analytics engine client 110D. At a high level, the carbon emissions data analytics engine configuration engine 110A operates to generate interface data (e.g., carbon emissions interface data and simulation interface data). Interface data includes user interface elements, carbon emissions data, and dashboard data associated with scenarios versioning and simulation and optimization operations.

User interfaces allow effective operation and control by users while the customer relationship management system simultaneously perform computing operations. Interface data can include graphical user interfaces that allow users to interact with carbon emissions management system (e.g., carbon emissions management tool) through graphical user interface elements. A graphical user interface can include a dashboard that provides a visual display of data (e.g., carbon emissions interface data and simulation interface data).

Turning to FIG. 2E, FIG. 2E illustrates a baseline interface 250 that supports presenting carbon emissions baseline data associated with client data. The baseline interface 250 can include a dimensions interface portion 250A, a filter interface portion 250B, and baseline information interface portion 250C. The baseline dimensions interface portion can include a plurality of selectable attributes (e.g., value chain, value chain sub buckets, brand, geography, product, and date) that can be selected to generate corresponding carbon emissions data associated with the selected attributes. The filter interface portion 250B includes a plurality of filters (e.g., brand, data, and value chain) that can also be selected to update the carbon emissions data associated with the selected filters. The baseline information interface portion 250C can include values of selected attributes 252 (e.g., value chain: including product conception, sourcing, manufacturing, distribution, and use and end of life; and value chain sub buckets: company facilities and vehicles, electricity consumption, employee and business related emission, etc.).

Turning to FIG. 2F, FIG. 2F illustrates an initiatives tracking interface 260 that supports presenting carbon emissions initiatives data associated with a client. The initiatives tracking interface 280 identifies a particular initiative undertaken by a client and corresponding carbon emissions initiative data. Carbon emissions initiatives data can include text information 262 (e.g., description, objectives, responsible employee) and graphical visualizations 264 (e.g., total emissions graph including current statistical data).

Turning to FIG. 2G, FIG. 2G illustrates a simulation interface 270 that supports presenting carbon emissions simulation data associated with a client. The simulation interface 270 includes a simulation configuration interface portion 272A and a simulation data interface portion 272B. The simulation configuration interface portion 272A include a plurality of configurable simulation attributes 274 that can be used to run simulations. The simulation data interface portion 272B can include carbon emissions simulation data associated with corresponding activity that is configured via the simulation configuration interface portion 272A. The simulations data interface portion 272B can include both text information and graphical visualizations 276 that are used to present simulations results.

Turning to FIG. 2H, FIG. 2H illustrates an optimization interface 280 that supports presenting carbon emissions optimization data associated with a client. The optimization interface 280 includes selectable tabs (e.g., demand forecasting 280A and inventory optimization 282B) that can be selected to provide carbon emissions optimization data associated with the corresponding tabs. The optimization interface 280 also includes an optimization inventory management interface portion 282 and an optimization carbon emissions data interface portion 284. The optimization inventory management interface portion 282 provide a plurality of base optimization scenario parameters 286 (e.g., scenario start data, scenario end date, capacity moves, and capacity moves steps) that are be configurable for demand forecasting. The optimization carbon emissions data interface portion 284 can include text information 284A (e.g., brand, product type, and SKU) and graphical visualizations 284B (e.g., forecast over time graph) that are retrieved and used to present carbon emissions optimization data. Other variations and combinations of carbon emissions data associated with baseline interface 250, initiatives tracking interface 260, simulation interface 270, and optimization interface 280 are contemplated with embodiments described herein.

### Exemplary Methods

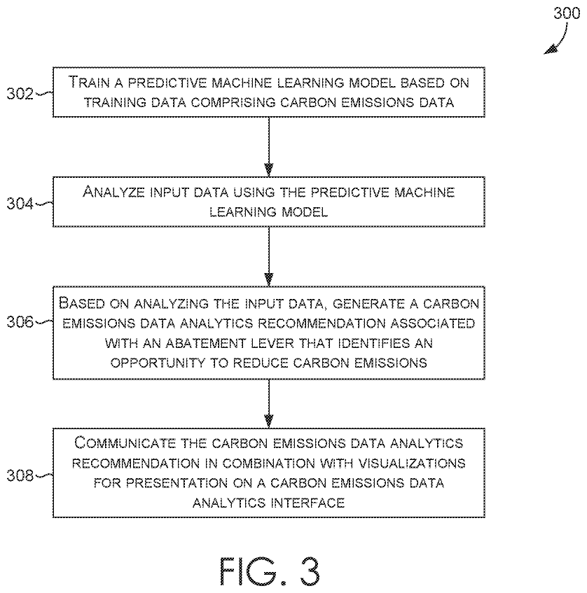

With reference to FIGS. 3, 4 and 5, flow diagrams are provided illustrating methods for providing carbon emissions data analytics recommendations (“recommendations”) using a carbon emissions data analytics engine (“analytics engine”) in a carbon emissions management system. The methods may be performed using the carbon emissions management system described herein. In embodiments, one or more computer-storage media having computer-executable or computer-useable instructions embodied thereon that, when executed, by one or more processors can cause the one or more processors to perform the methods (e.g., computer-implemented method) in the carbon emissions management system (e.g., a computerized system or computing system).

Turning to FIG. 3, a flow diagram is provided that illustrates a method 300 for providing carbon emissions data analytics recommendations (“recommendations”) using a carbon emissions data analytics engine (“analytics engine”) in a carbon emissions management system. At block 302, train a predictive machine learning model based on training data comprising carbon emissions data. At block 304, analyze input data using the predictive machine learning model. At block 306, based on analyzing the input data, generate carbon emissions data analytics recommendation associated with an abatement lever that identifies an opportunity to reduce carbon emissions. At block 308, communicate the carbon emissions data analytics recommendation in combination with visualizations for presentation on a carbon emissions data analytics interface.

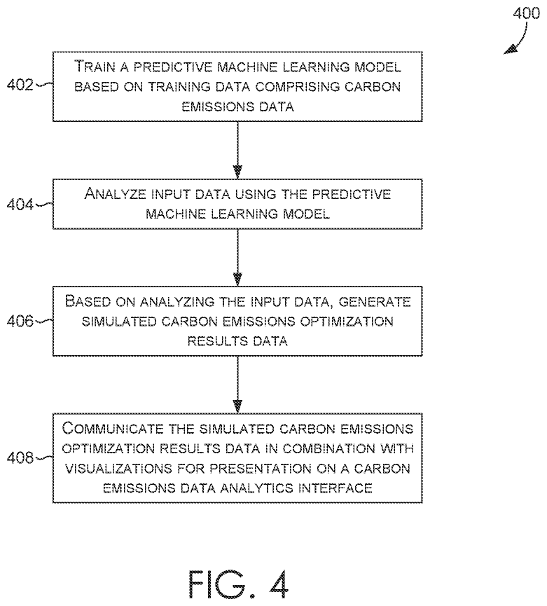

Turning to FIG. 4, a flow diagram is provided that illustrates a method 400 for carbon emissions data analytics recommendations (“recommendations”) using a carbon emissions data analytics engine (“analytics engine”) in a carbon emissions management system. At block 402, train a predictive machine learning model based on training data comprising carbon emissions data. At block 404, analyze input data using the predictive machine learning model. At block 406, based on analyzing the input data, generate simulated carbon emissions optimization results data. At block 308, communicate the simulated carbon emission optimization results data in combination with visualizations for presentation on a carbon emissions data analytics interface.

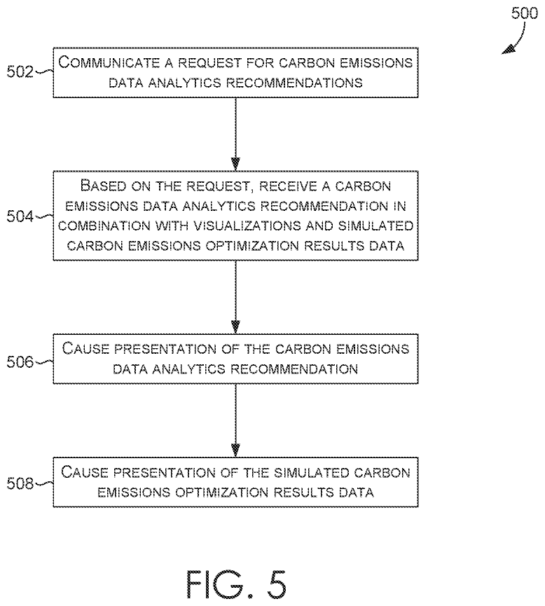

Turning to FIG. 5, a flow diagram is provided that illustrates a method 500 for providing carbon emissions data analytics recommendations (“recommendations”) using a carbon emissions data analytics engine (“analytics engine”) in a carbon emissions management system. At block 502, communicate a request for carbon emissions data analytics recommendations. At block 504, based on the request, receive a carbon emissions data analytics recommendation in combination with visualizations and simulated carbon emission optimization results data. At block 506, cause presentation of the carbon emissions data analytics recommendation. At block 508, cause presentation of the simulated carbon emissions results data.

### Additional Support for Detailed Description of the Invention

### Example Distributed Computing System Environment

Referring now to FIG. 6, FIG. 6 illustrates an example distributed computing environment 600 in which implementations of the present disclosure may be employed. In particular, FIG. 6 shows a high level architecture of an example cloud computing platform 610 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 600 that includes cloud computing platform 610, rack 620, and node 630 (e.g., computing devices, processing units, or blades) in rack 620. The technical solution environment can be implemented with cloud computing platform 610 that runs cloud services across different data centers and geographic regions. Cloud computing platform 610 can implement fabric controller 640 component for provisioning and managing resource allocation, deployment, upgrade, and management of cloud services. Typically, cloud computing platform 610 acts to store data or run service applications in a distributed manner. Cloud computing infrastructure 610 in a data center can be configured to host and support operation of endpoints of a particular service application. Cloud computing infrastructure 610 may be a public cloud, a private cloud, or a dedicated cloud.

Node 630 can be provisioned with host 650 (e.g., operating system or runtime environment) execution a defined software stack on node 630. Node 630 can also be configured to perform specialized functionality (e.g., compute nodes or storage nodes) within cloud computing platform 610. Node 630 is allocated to run one or more portions of a service application of a tenant. A tenant can refer to a customer utilizing resources of cloud computing platform 610. Service application components of cloud computing platform 610 that support a particular tenant can be referred to as a tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 630, nodes 630 may be partitioned into virtual machines (e.g., virtual machine 652 and virtual machine 654). Physical machines can also concurrently run separate service applications. The virtual machines or physical machines can be configured as individualized computing environments that are supported by resources 660 (e.g., hardware resources and software resources) in cloud computing platform 610. It is contemplated that resources can be configured for specific service applications. Further, each service application may be divided into functional portions such that each functional portion is able to run on a separate virtual machine. In cloud computing platform 610, multiple servers may be used to run service applications and perform data storage operations in a cluster. In particular, the servers may perform data operations independently but exposed as a single device referred to as a cluster. Each server in the cluster can be implemented as a node.

Client device 680 may be linked to a service application in cloud computing platform 610. Client device 680 may be any type of computing device, which may correspond to computing device 600 described with reference to FIG. 6, for example, client device 680 can be configured to issue commands to cloud computing platform 610. In embodiments, client device 680 may communicate with service applications through a virtual Internet Protocol (IP) and load balancer or other means that direct communication requests to designated endpoints in cloud computing platform 610. The components of cloud computing platform 610 may communicate with each other over a network (not shown), which may include, without limitation, one or more local area networks (LANs) and/or wide area networks (WANs).

### Example Computing Environment

Having briefly described an overview of embodiments of the present invention, an example operating environment in which embodiments of the present invention may be implemented is described below in order to provide a general context for various aspects of the present invention. Referring initially to FIG. 7 in particular, an example operating environment for implementing embodiments of the present invention is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output ports 718, input/output components 720, and illustrative power supply 722. Bus 710 represents what may be one or more buses (such as an address bus, data bus, or combination thereof). The various blocks of FIG. 7 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 7 is merely illustrative of an example computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc.

### Additional Structural and Functional Features of Embodiments of the Technical Solution

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present invention may generally refer to the technical solution environment and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

What is claimed is:

1. A computerized system comprising:
one or more computer processors; and
computer memory storing computer-useable instructions that, when used by the one or more computer processors, cause the one or more computer processors to perform operations comprising:
accessing, at a carbon emissions data analytics engine, input data comprising activity-carbon-emissions data, wherein the activity-carbon-emissions data is a mapping of carbon emission factors to activity data of activities of a value chain model,
wherein a carbon emissions factor is associated with an activity of the value chain model, the carbon emissions factor quantifies a pollutant that is released when the activity is performed;
using a carbon emissions data analytics model associated with a simulation computation and machine learning engine, generating carbon emissions associated with the activities of the activity-carbon-emissions data;
based on the predicted carbon emissions of the activity-carbon emissions, generating a carbon emissions data analytics recommendation; and
causing display of the carbon emissions data analytics recommendation.

2. The system of claim 1, wherein the carbon emissions data analytics recommendation comprises simulated carbon emissions optimization results data based on the predicted carbon emissions data associated with the activities of the value chain model.

3. The system of claim 1, wherein the carbon emissions data analytics recommendation comprises a plurality of abatement levers that support quantifying how to reduce the predicted carbon emissions associated with the activities of the value chain model.

4. The system of claim 3, further comprising simulating an effect of selecting one or more of the plurality of abatement levers on a carbon emissions baseline of the value chain model.

5. The system of claim 1, wherein causing display of the carbon emissions data analytics recommendation comprises generating a plurality of dashboard visualizations having graphical interface elements corresponding to carbon emissions output data associated with the carbon emissions data analytics recommendation.

6. The system of claim 1, further comprising:
pre-processing carbon emission factors from a plurality of carbon emissions factors data sources, wherein pre-processing the carbon emissions factors comprises retrieving, merging and augmenting the carbon emissions factors;
using a matching logic, mapping carbon emissions factors to activity data, wherein the activity data is associated with activities of the value chain model; and
based on mapping the carbon emissions factors to the activity data, generating the activity-carbon-emissions data comprising synthetic carbon emissions data.

7. The system of claim 1, wherein the carbon emissions data analytics engine is a collaborative platform that supports dashboards, scenario versioning and simulations, and comparisons to baseline carbon emissions data.

8. One or more computer-storage media having computer-executable instructions embodied thereon that, when executed by a computing system having a processor and memory, cause the processor to:
access, at a carbon emissions data analytics engine, input data comprising activity-carbon-emissions data, wherein the activity-carbon-emissions data is a mapping of carbon emission factors to activity data of activities of a value chain model,
wherein a carbon emissions factor is associated with an activity of the value chain model, the carbon emissions factor quantifies a pollutant that is released when the activity is performed;
use a carbon emissions data analytics model associated with a simulation computation and machine learning engine to predict carbon emissions associated with the activities of the activity-carbon-emissions data;
based on the predicted carbon emissions of the activity-carbon emissions, generate a carbon emissions data analytics recommendation; and
cause display of the carbon emissions data analytics recommendation.

9. The media of claim 8, wherein the carbon emissions data analytics recommendation comprises simulated carbon emissions optimization results data based on the predicted carbon emissions data associated with the activities of the value chain model.

10. The media of claim 8, wherein the carbon emissions data analytics recommendation comprises a plurality of abatement levers that support quantifying how to reduce the predicted carbon emissions associated with the activities of the value chain model.

11. The media of claim 10, further comprising simulating an effect of selecting one or more of the plurality of abatement levers on a carbon emissions baseline of the value chain model.

12. The media of claim 8, wherein causing display of the carbon emissions data analytics recommendation comprises generating a plurality of dashboard visualizations having graphical interface elements corresponding to output data associated with the carbon emissions data analytics recommendation.

13. The media of claim 8, further comprising:
pre-processing carbon emission factors from a plurality of carbon emissions factors data sources, wherein pre-processing the carbon emissions factors comprises retrieving, merging and augmenting the carbon emissions factors;
using a matching logic, mapping carbon emissions factors to activity data, wherein the activity data is associated with activities of the value chain model; and
based on mapping the carbon emissions factors to the activity data, generating the activity-carbon-emissions data comprising synthetic carbon emissions data.

14. The media of claim 8, wherein the carbon emissions data analytics engine is a collaborative platform that supports dashboards, scenario versioning and simulations, and comparisons to baseline carbon emissions data.

15. A computer-implemented method, the method comprising:
accessing, at a carbon emissions data analytics engine, input data comprising activity-carbon-emissions data, wherein the activity-carbon-emissions data is a mapping of carbon emission factors to activity data of activities of a value chain model,
wherein a carbon emissions factor is associated with an activity of the value chain model, the carbon emissions factor quantifies a pollutant that is released when the activity is performed;
using a carbon emissions data analytics model associated with a simulation computation and machine learning engine, predicting carbon emissions associated with the activities of the activity-carbon-emissions data;
based on the predicted carbon emissions of the activity-carbon emissions, generating a carbon emissions data analytics recommendation; and
causing display of the carbon emissions data analytics recommendation.

16. The method of claim 15, wherein the carbon emissions data analytics recommendation comprises simulated carbon emissions optimization results data based on the predicted carbon emissions data associated with the activities of the value chain model.

17. The method of claim 15, wherein the carbon emissions data analytics recommendation comprises a plurality of abatement levers that support quantifying how to reduce the predicted carbon emissions associated with the activities of the value chain model.

18. The method of claim 17, further comprising simulating an effect of selecting one or more of the plurality of abatement levers on a carbon emissions baseline of the value chain model.

19. The method of claim 15, wherein causing display of the carbon emissions data analytics recommendation comprises generating a plurality of dashboard visualizations having graphical interface elements corresponding to output data associated with the carbon emissions data analytics recommendation.

20. The method of claim 16, further comprising:
pre-processing carbon emission factors from a plurality of carbon emissions factors data sources, wherein pre-processing the carbon emissions factors comprises retrieving, merging and augmenting the carbon emissions factors;
using a matching logic, mapping carbon emissions factors to activity data, wherein the activity data is associated with activities of the value chain model; and
based on mapping the carbon emissions factors to the activity data, generating the activity-carbon-emissions data comprising synthetic carbon emissions data.
